(19) United States
(12) Patent Application Publication
(10) Pub. No.: US 2024/0349719 A1
(43) Pub. Date: Oct. 24, 2024

(54) HIGHLY LOADED BROMOXYNIL FORMULATIONS

(71) Applicant: ADAMA AUSTRALIA PTY LIMITED, New South Wales (AU)

(72) Inventors: Andrew HORSFIELD, St. Leonards, New South Wales (AU); Peter VAUGHAN, Caboolture, Queensland (AU)

(21) Appl. No.: 18/685,743

(22) PCT Filed: Aug. 25, 2022
(86) PCT No.: PCT/AU2022/051045

§ 371 Date: Feb. 22, 2024

(30) Foreign Application Priority Data
Aug. 25, 2021 (AU) 2021221815

(51) Int. Cl. A01N 37/34; A01N 25/04; A01N 25/32; A01N 43/40; A01N 43/56; A01N 43/80; A01P 13/02

(52) U.S. Cl. CPC A01N 37/34; A01N 25/04; A01N 25/32; A01N 43/40; A01N 43/56; A01N 43/80; A01P 13/02

(57) ABSTRACT

A highly loaded bromoxynil herbicidal formulation including two emulsifiers and at least one suitable solvent is provided, in which the formulation has low flammability and cold stability. The formulation of the may include one or more other active ingredients.

### TECHNICAL FIELD

The invention relates to highly loaded herbicidal formulations containing bromoxynil, either alone or together with one or more other active ingredients. In particular, the invention provides solo and co-formulations aimed at overcoming problems encountered with bromoxynil formulations in the past.

### BACKGROUND ART

Bromoxynil (3,5-Dibromo-4-hydroxybenzonitrile) is a nitrile herbicide that is known to inhibit photosynthesis. It is known to be applied post-emergently to control annual broad-leaf weeds, especially in cereal crops, turf and pastures, as well as in horticultural, fallow land and non-crop situations generally.

Application rates for bromoxynil can be relatively high, up to 1200 g ai/ha. Bromoxynil is often used with other herbicides either in tank mixtures or co-formulations. The most common forms of bromoxynil in agrochemical formulations include the octanoate and heptanoate esters, sometimes as mixtures of the two.

Due to the low water solubility of these esters, bromoxynil is often formulated in emulsifiable concentrate (EC) formulations. Typical bromoxynil concentrations of EC formulations range from 140 to 280 g ai/L. Often the formulation includes a second active ingredient, such as a phenoxy ester (MCPA is an example), a phytoene desaturase (PDS) inhibitor such as diflufenican or picolinafen or an active ingredient with another mode of action, such as a HPPD inhibitor and a herbicide safener.

Stable EC formulations containing bromoxynil in combination with a PDS inhibitor such as diflufenican and optionally at least one other herbicide e.g. MCPA are currently limited to a maximum concentration of bromoxynil of 250 g/L.

Further, PDS and bromoxynil EC co-formulations are prone to form crystals at low temperatures, due to low solubility of one or both active ingredients in organic solvents.

Key issues for EC formulations with PDS inhibitors are therefore cold stability and dilution stability.

There are limitations for creating stable and highly loaded bromoxynil EC co-formulations with a PDS inhibitor. Examples are the availability of suitable solvent and emulsifier combinations, the solubility of the PDS inhibitor in the solvents and the solubility of the solvents in water. One prior art solution was to use a lower rate of bromoxynil in products such as Flight® (or Paragon® Xtra), which contains picolinafen 35+MCPA 350+bromoxynil 210 EC, applied at a rate of up to 720 mL/ha. However, for hard to control weed species such as Raphanus raphanistrum, application of ˜150 g bromoxynil/ha does not always provide sufficient control even when applied in combination with a PDS inhibitor and MCPA. It may be necessary to add to the tank mix a solo bromoxynil EC formulation to deliver a higher bromoxynil dose.

An EC formulation containing picolinafen 25+bromoxynil 250 (Eliminar® C) with 554 g/L Solvesso 150 (or equivalent) was developed by Nufarm to provide a product with sufficient bromoxynil for use on hard to control species. However, growers often need to apply a third active ingredient, such as MCPA 2-ethylhexylester (2-EHE), to improve control. The high solvent concentration of this formulation and requirement for the addition of MCPA 2-EHE as a tank mix partner is a less efficient option in terms of increased volume to procure, store, handle and mix, compared with highly loaded co-formulations or tank mixtures of highly loaded solo products.

EP0210818A lists a range of potential solvents for creating emulsifiable concentrates containing bromoxynil. The formulations listed in the examples are limited to relatively low concentrations, such as bromoxynil 224 g/L in Solvesso 150 with Atlox 4855 and Agrilan A surfactants/emulsifiers. Since this patent was published, a wide range of formulations have been commercialized globally with bromoxynil at higher concentrations and with differing emulsifiers and solvents.

While higher concentration EC formulations of >250 g ai/L of bromoxynil have been commercialised, they rely on specific solvents/partner active ingredients to achieve these loadings. Examples of issues with these higher loaded formulations include:
An EC formulation of Bromoxynil octanoate 280+MCPA isooctyl 280, using acetophenone as the solvent and 70 g/L of a 1:1 ratio of dodecylbenzene sulphonate+alkoxylated alkyl phenol emulsifiers: higher loadings of this combination/ratio of emulsifiers and solvent were less stable, due to the high loading and the relatively high water solubility of acetophenone resulting in crystallization upon dilution. If bromoxynil is not in a stable EC formulation so as to avoid crystallization in-can and on dilution, significant issues can occur, such as blocked filters and nozzles on commercial spray equipment;
An EC formulation of Bromoxynil 300+Diflufenican 30: due to the low solubility of diflufenican in many solvents, this formulation required cyclohexyl acetate which is costly to produce and has limited suppliers. Additionally, two other solvents were required to achieve the desired loading including NMP (N-methyl-2 pyrrolidone) and isooctyl acetate, which increases the number of raw materials required to formulate this product;
A Bromoxynil 400 EC formulation: while this formulation is stable and effective, it includes a shorter chain aromatic solvent i.e. Solvesso 100; which has a low flash point (˜48° C.). Increased flammability of this formulation creates a hazard for storage, transport and use compared with lower concentration formulations which use solvents with a higher flash point.

There is therefore a need for creation of a highly loaded bromoxynil formulation which avoids some or all of the problems referred to above—lack of stability, high cost, high raw material count and fire hazard-or which at least provides a useful alternative.

Reference to any prior art in the specification is not an acknowledgment or suggestion that this prior art forms part of the common general knowledge in any jurisdiction or that this prior art could reasonably be understood, regarded as relevant, and/or combined with other pieces of prior art by a skilled person in the art.

### SUMMARY OF THE INVENTION

Surprisingly, it has been found that bromoxynil can be highly loaded as a solo formulation up to at least 400 g/L, using a combination of low flammability solvents with low and high-water solubility to balance in-can and dilution stability, providing a suitable emulsifier system is used. This formulation is designed to avoid the flammability issue of the prior art Bromoxynil 400 EC formulation.

Additionally, it has been discovered that stable co-formulations can be created for highly loaded bromoxynil co-formulations using lower concentrations of solvents and a higher concentration of emulsifiers.

In a first aspect, the present invention provides a highly loaded bromoxynil EC formulation having a loading of at least 275 g ai/L and including two emulsifiers and at least one suitable solvent, wherein the formulation has low flammability and cold stability.

As used in this specification and claims, the term ‘low flammability’ means that the formulation has a flash point in excess of 60° C. A flash point of 60° C. or less would require the formulation to be classified as a flammable liquid.

As used in this specification and claims, the term ‘cold stability’ means that the formulation is cold stable according to Method CIPAC MT 39.3 published by the Collaborative International Pesticides Analytical Council.

Bromoxynil may be present as the octanoate ester. However, the invention is not limited to this. Other esters, such as the heptanoate ester and the butyrate ester, for example, may be suitable. In one embodiment, bromoxynil is present as a mixture of esters, being two or three esters chosen from the heptanoic ester, the octanoic ester and the butyrate ester.

In a first embodiment, bromoxynil is the sole active ingredient and the loading of bromoxynil is about 400 g ai/L.

Examples of suitable emulsifiers for this embodiment include alkylbenzene sulfonate calcium salts, such as linear dodecylbenzene sulfonate calcium salt in 2-ethyl hexanol/propylene glycol, available as Nansa® EVM 70/2E, for example; and a castor oil-based emulsifier, such as an ethoxylated castor oil, available as Emulsogen® EL 360, for example.

An example of a solvent suitable for this embodiment is a high solvency aromatic solvent, such as a naphtha solvent available as Solvesso 200 (B), for example. If desired, a second or co-solvent may be included in the first embodiment. An example of a suitable co-solvent is NMP.

The formulation in this embodiment may include other suitable adjuvants, one example being an antifoam agent, available as Gensil® 2000, for instance.

In second embodiment, the formulation has a second active ingredient, the loading of bromoxynil being at least 280 g ai/L and the total active ingredient loading being more than about 330 g/L.

Preferably, in this embodiment, the second active ingredient is fluroxypyr (4-amino-3,5-dichloro-6-fluoro-2-pyridyloxyacetic acid). It is especially preferred that the formulation contains about 300 g/L of bromoxynil and about 150 g/L of fluroxypyr.

Examples of suitable emulsifiers for this embodiment include alkylbenzene sulfonate calcium salts, such as linear dodecylbenzene sulfonate calcium salt in 2-ethyl hexanol/propylene glycol, available as Nansa® EVM 70/2E, for example, and alkoxylated alkylphenols, such as Termul® 200, for example.

An example of a solvent suitable for this embodiment is acetophenone, noting that other solvents or solvent combinations may also be suitable. It is preferred that this embodiment uses a single solvent.

The formulation in this second embodiment may include other suitable adjuvants, one example being an antifoam agent, available as Gensil® 2000, for instance. In a third embodiment, the formulation includes MCPA, the loading of bromoxynil being at least about 275 g ai/L, the total active ingredient loading being more than about 560 g/L.

Optionally, for this embodiment the formulation may include a third active ingredient, an example being picolinafen (N-(4-Fluorophenyl)-6-[3-(trifluoromethyl) phenoxy]-2-pyridinecarboxamide).

Preferably, in this embodiment, the formulation contains about 275 to about 280 g/L of bromoxynil, about 280 to about 290 g/L if MCPA and about 29 to about 40 g/L of picolinafen.

Examples of suitable emulsifiers for this embodiment include alkoxylated alkylphenols, such as Termul® 200, for example and a linear dodecylbenzene sulphonate, available as Rhodacal 60/BE-A, for example, as the calcium salt in a 2-ethylexanol solution. An example of a solvent suitable for this embodiment is acetophenone, noting that other solvents may also be suitable. It is preferred that this embodiment uses a single solvent.

In a second aspect, the invention provides a highly loaded bromoxynil EC formulation having a loading of at least 250 g ai/L, two emulsifiers and a single suitable solvent, wherein the formulation has low flammability and cold stability.

In a first embodiment of this aspect, bromoxynil is the sole active ingredient.

In a second embodiment of this aspect, the formulation includes at least one additional active ingredient. This or each additional active ingredient may be chosen from a PDS inhibitor other than diflufenican, the PDS inhibitor being loaded at more than 25 g/L; and MCPA. Preferably, the PDS inhibitor is picolinafen.

For both the first and the second embodiments:
the single solvent is preferably acetophenone and or an aromatic solvent, such as a naphtha solvent or a C9 to C11 aromatic hydrocarbon. When the solvent is acetophenone, it is preferably present in a concentration of less than 200 g/L.
the emulsifiers are preferably from the group consisting of alkylbenzene sulfonate calcium salts, castor oil, ethoxylated castor oil, alkoxylated alkylphenols and linear dodecylbenzene sulphonates.

For the second embodiment, one formulation includes at least one PDS inhibitor at a concentration of more than 25 g/L and MCPA 2-EHE. MCPA 2-EHE can act as both a herbicide and co-solvent due to the partial solubility of bromoxynil and the PDS inhibitor in MCPA 2-EHE.

In a further aspect, the invention provides a highly loaded bromoxynil EC formulation having a loading of more than 210 g ai/L, at least one additional active ingredient and including two emulsifiers and at least one suitable solvent, wherein the formulation has low flammability and cold stability and the total active ingredient loading is more than 525 g/L.

For this aspect, the one or more additional active ingredients, the emulsifiers and the solvent may be the same as listed above for the other aspects.

In another aspect of the present invention there is provided a method for controlling weeds comprising applying the formulation according to any of the above aspects of the invention to any of a plant, crop, pasture, fallow between crops, firebreaks, alongside pathways or roads and around buildings to control the weeds.

As used herein, except where the context requires otherwise, the term “comprise” and variations of the term, such as “comprising”, “comprises and “comprised”, are not intended to exclude further additives, components, integers or steps.

Further aspects of the present invention described in the preceding paragraphs will become apparent from the following description, given by way of embodiments and/or examples.

### DETAILED DESCRIPTION OF PREFERRED EMBODIMENTS

Reference will now be made in detail to certain embodiments of the invention. While the invention will be described in conjunction with the embodiments and/or examples, it will be understood that the intention is not to limit the invention to those embodiments/examples. On the contrary, the invention is intended to cover all alternatives, modifications, and equivalents, which may be included within the scope of the present invention.

One skilled in the art will recognize many methods and materials similar or equivalent to those described herein, which could be used in the practice of the present invention. The present invention is in no way limited to the methods and materials described. It will be understood that the invention disclosed and defined in this specification extends to all alternative combinations of two or more of the features mentioned or evident from the text. All of these different combinations constitute various alternative aspects of the invention.

For the purposes of interpreting this specification, terms used in the singular will also include the plural and vice versa.

### Example 1

### Highly Loaded Bromoxynil Solo Formulation

By way of example, a highly loaded aqueous EC formulation containing a bromoxynil concentration of about 400 g ai/L was prepared. Bromoxynil was present as the octanoate. The components are as set out in Table 1:

TABLE 1
Components

| Content | | Purpose in | |
|---|---|---|---|
| g/L | Component | Formulation | Supplier |
| 600.29 | Bromoxynil | active | Zhejang Heben Pesticide |
| | Octanoate | ingredient | & Chemicals Co., Ltd |
| | TGAC 97% | | |
| 52.50 | NANSA EVM 70 | emulsifier | Huntsman Australia Pty Ltd |
| | 2/E | | |
| 17.50 | EMULSOGEN EL | emulsifier | Clariant (Australia) Pty Ltd |
| | 360 | | |
| 50.00 | NMP | co-solvent | Recohem Inc |
| 465.85 | Solvesso 200 (B) | solvent | Australasian Solvents & |
| | | | Chemicals Company |
| | | | Pty Ltd |
| 0.03 | Gensil 2000 | antifoam | Solvay Interox Pty Ltd |

Details of the components are as set out in Table 2:

TABLE 2
Component Details

| Trade Name | IUPAC NAME | CAS # |
|---|---|---|
| Bromoxynil Octanoate | 2,6-dibromo-4-cyanophenyl | 1689-99-2 |
| TGAC 97% | | |
| NANSA EVM 70 | benzenesulfonic acid, 4-C10-14- | 91094-26-6 |
| 2/E | alkyl derivs., calcium salt | |
| EMULSOGEN EL 360 | ethoxylated castor oil | 61791-12-6 |
| NMP | 1-methyl-2-pyrrolidone | 872-50-4 |
| Solvesso 200 (B) | solvent naphtha (petroleum), | 64742-94-5 |
| | heavy | |
| Gensil 2000 | polydimethylsiloxane | 63148-62-9 |

To prepare the formulation, by way of example, the following method and the sequence of operations were followed.
1. Bromoxynil Octanoate Technical requires melting, being a waxy solid at ambient temperature. Its melting point is 46° C.
2. Melt the required amount of Bromoxynil Octanoate Technical in a water bath at 60° C. and maintain it in a completely molten state prior to addition.
3. Charge the NMP into a suitable vessel equipped with stirrer.
4. Commence stirring and add Solvesso 200 (B).
5. Add NANSA EVM 70 2/E. Maintain stirring.
6. Add EMULSOGEN EL 360. Maintain stirring.
7. Add molten Bromoxynil Octanoate Technical. Maintain stirring.
8. Add Gensil 2000 and blend for 30 mins.
9. Confirm the active ingredients content by QChem Laboratories Analytical Method QCM-146.01.
10. Adjust with Solvesso 200 (B) as required.
   Product Specification and Analysis 5000 mL of prototype formulation was prepared in the laboratory exactly according to the above method. A specification was then developed by determining properties of the laboratory prepared prototype formulation and applying acceptable limits of manufacturing variation to the results obtained.

### Packaging Stability

Two samples of the 5000 mL of product formulated as above were each packaged in 1000 mL screwcap, level 3 fluorinated HDPE. The samples remained in their containers and were stored in an air-conditioned facility at approximately 21° C. for the period prior to ambient temperature, elevated temperature and cold temperature storage.

The time zero sample was stored in a locked cabinet for the duration of the elevated temperature storage period.

On the day of initiation of the accelerated storage trial, each of the samples in their unopened containers were weighed on a top pan balance (Mettler PJ3600 Delta Range: SNR J29589) to determine a starting weight (for use as a comparison with weights at the conclusion of the storage period).

No observable degradation, deformation, discolouration or etching of the container or lid was evident after accelerated storage. No odour was detectable emanating from the seal.

No appreciable weight difference was determined over the 14 day period for both ambient and 54° C. storage conditions.

Analysis of the time zero (T01) sample is shown in Table 3:

TABLE 3
Analysis Time Zero (Ambient) Sample

| Determination | Method | Specification | Analysis | Result |
|---|---|---|---|---|
| Appearance, | Visual | Clear amber | Clear amber | PASS |
| Physical State | | liquid | liquid | |
| Odour | Olfactory | Slight naphtha | Slight naphtha | PASS |
| | | odour | odour | |
| pH 1% v/v | CIPAC MT 75.3 | 4.50-6.50 | 5.62 | PASS |
| dilution | | | | |
| Density @ 20° C. | CIPAC MT 3.2 | 1.181-1.191 g/mL | 1.186 g/mL | PASS |
| Emulsion | CIPAC MT 36.3 | Initial emulsification | Initial emulsification | PASS |
| Characteristics | 1.5 mL/100 | uniform | uniform | |
| CIPAC | mL | 30 min < 2.0 mL | 30 min 0.30 mL | |
| Standard | | cream, trace oil | cream, nil oil | |
| Water D | | 2 h < 2.0 mL | 2 h 0.45 mL | |
| Ambient | | cream, trace oil | cream, nil oil | |
| Temp. 23° C. | | 24 h re- | 24 h re- | |
| | | emulsification | emulsification | |
| Persistent Foam | CIPAC MT 47.2 | max 60 mL foam | Initial 18 mL | PASS |
| Standard Water | 1.8 mL/200 | after 1 min | After 10 sec: 15 mL | |
| | | | After 1 min: 12 mL | |
| | | | After 3 min: 12 mL | |
| Content | QCM-146.01 | 380-420 g/L | 407 g/L | PASS |
| Bromoxynil | | | | |
| present as the | | | | |
| octanoate ester | | | | |

The sample designated for elevated temperature storage (Accelerated Stability sample TAS1) was placed into a thermostatically controlled oven (VWR Mini Incubator: SNR 0811V1169) and heated to 54±2° C., for a period of 14 days. At the end of this period, the sample was removed from the oven and placed into a desiccation chamber to allow cooling to ambience.

The sample was analysed as set out in Table 4:

TABLE 4
Analysis Accelerated Stability Sample (TAS1)

| Determination | Method | Specification | Analysis | Result |
|---|---|---|---|---|
| Appearance, | Visual | Clear amber | Clear amber | PASS |
| Physical State | | liquid | liquid | |
| Odour | Olfactory | Slight naphtha | Slight naphtha | PASS |
| | | odour | odour | |
| pH 1% v/v | CIPAC MT 75.3 | 4.50-6.50 | 5.62 | PASS |
| dilution | | | | |
| Density @ 20° C. | CIPAC MT 3.2 | 1.181-1.191 g/mL | 1.186 g/mL | PASS |
| Emulsion | CIPAC MT 36.3 | Initial emulsification | Initial emulsification | PASS |
| Characteristics | 1.5 mL/100 mL | uniform | uniform | |
| CIPAC | | 30 min < 2.0 mL | 30 min 0.30 mL | |
| Standard | | cream, trace oil | cream, nil oil | |
| Water D | | 2 h < 2.0 mL | 2 h 0.55 mL | |
| Ambient | | cream, trace oil | cream, nil oil | |
| Temp. 23° C. | | 24 h re- | 24 h re- | |
| | | emulsification | emulsification | |
| | | complete | complete | |
| | | 24.5 h < 2.0 mL | 24.5 h 0.40 mL | |
| | | cream, trace oil | cream, nil oil | |
| Persistent Foam | CIPAC MT 47.2 | max 60 mL foam | Initial 18 mL | PASS |
| Standard Water | 1.8 mL/200 | after 1 min | After 10 sec: 15 mL | |
| | | | After 1 min: 15 mL | |
| | | | After 3 min: 14 mL | |
| Content | QCM-146.01 | 380-420 g/L | 409 g/L | PASS |
| Bromoxynil | | | | |
| present as the | | | | |
| octanoate ester | | | | |

### Preparation of Cold Temperature Stability Sample

A sample of the formulation was prepared for low temperature stability testing by placing 100 ml of the post accelerated storage stability formulation sample (TAS1) into a 100 mL ASTM D96 graduated centrifuge tube and storing it in a refrigerated cabinet (Esatto Model EBF93W: SNR 5G386) at a temperature of 0° C.±2° C. for a total of 7 days.

The result is shown in Table 5:

TABLE 5
Cold Temperature Stability Sample (TCD1)

| Determination | Method | Specification | Analysis | Result |
|---|---|---|---|---|
| Low Temperature | CIPAC MT | <0.05 mL | nil | PASS |
| Stability | 39.3 | separated | separated | |
| | After 7 days | material | material | |

### Descriptions of Methods Used

The relevant test parameters for emulsifiable concentrates (EC) formulations are set out in Section 3.2, Table 19 of the Australian Pesticides & Veterinary Medicines Authority (APVMA) Guidelines for the Generation of Storage Stability Data for Agricultural Chemical Products (Version 2, 22 Jul. 2015). An outline summary of each method employed follows:
Appearance, Physical State & Colour

These tests were performed visually and are described in descriptive terms.
Odour

This test was performed organoleptically and involves the use of descriptive terms.
Density MT 3.2

The weights of equal volumes of the material are compared in a capillary stoppered pycnometer.
pH CIPAC MT 75.3

The pH value of a mixture of a sample with water is determined by means of a pH meter and electrode system.

Emulsion Characteristics CIPAC MT 36.3

An emulsion of known concentration in standard water is prepared. The stability of this emulsion is the assessed in terms of the amounts of free ‘oil’ or ‘cream’ which separates while the emulsion is allowed to stand undisturbed for 24 hours. The ability of the system to re-emulsify at the end of the 24 hours period is also determined.

Persistent Foam CIPAC MT 47.2

The sample is diluted in a measuring cylinder of standard dimensions which is inverted 30 times and the amount of foam created and remaining after certain times is measured.

Cold Temperature Stability of Liquid Formulations CIPAC MT 39.3

A sample is maintained at 0+2° C. for 7 days and the volume and nature of any separated material is recorded.
Active Constituent Content-Qchem Laboratories Analytical Method QCM-146.01

Bromoxynil Octanoate ester content is determined by gas chromatography using flame ionization detection and internal standardisation. The method is appropriately validated as per the APVMA Guidelines for the Validation of Analytical Methods for Active Constituents and Agricultural Products (Revision 1, Jul. 1, 2014).

In conclusion, the new EC formulation containing a bromoxynil concentration of about 400 g/L performs excellently in all requisite tests.

### Example 2

### Highly Loaded Bromoxynil Co-Formulation

Example 2 illustrates an embodiment of the second aspect of the invention-a co-formulation of bromoxynil with a second active ingredient, in this example being fluroxypyr. The total loading of the active ingredients is more than 330.g/L.

This embodiment of the co-formulation is identified as AD-AU-1624. It has two emulsifiers, a single solvent and an antifoaming agent. Details are in Table 6, below:

TABLE 6
Composition of AD-AU-1624 (fluroxypyr
150 + bromoxynil 300 EC)

| | | CAS | Purpose in |
|---|---|---|---|
| g/L | Component | number | Formulation |
| 450.21 | Bromoxynil octanoate | 1689-99-2 | Active ingredient |
| | 97% | | |
| 219.96 | Fluroxypyr meptyl | 81406-37-3 | Active ingredient |
| | 98.2% | | |
| 60 | Nansa EVM 70/2E | 90194-26-6 | Emulsifier |
| 40 | Termul 200 | 37251-69-7 | Emulsifier |
| 409.81 | Acetophenone | 98-86-2 | Solvent |
| 0.05 | Gensil 2000 | 63148-62-9 | Antifoam |

### Example 3

### Highly Loaded Bromoxynil Formulation—Two Additional Active Ingredients

Example 3 illustrates an embodiment of the invention—a co-formulation of bromoxynil with a second active ingredient, in this example being picolinafen, and a third active ingredient, in this example being MCPA-EHE. The total loading of the active ingredients is about 595 g/L. This embodiment of the formulation is identified as AD-AU-2109. It has two emulsifiers and a single solvent. Details are in Table 7, below:

TABLE 7
Composition of AD-AU-2109 (Picolinafen 29.5 +
Bromoxynil 275 + MCPA 290 EC)

| | | CAS | Purpose in |
|---|---|---|---|
| g/L | Component | number | Formulation |
| 29.95 | Picolinafen 98.5% | 137641-05-5 | Active ingredient |
| 411 | Bromoxynil octanoate | 1689-99-2 | Active ingredient |
| | 97.4% | | |
| 471 | MCPA 2-EHE 96% | 29450-45-1 | Active ingredient |
| 44 | Rhodacal 60/BE-A | 26264-06-2 | Emulsifier |
| 36 | Termul 200 | 37251-69-7 | Emulsifier |
| 179.4 | Acetophenone | 98-86-2 | Solvent |

### Example 4

### Highly Loaded Bromoxynil Formulation—Two Additional Active Ingredients

Example 4 illustrates an embodiment of the invention being similar to that in Example 3. The total loading of the active ingredients is about 600 g/L.

This embodiment of the formulation is identified as AD-AU-2110. It has two emulsifiers and a single solvent. Details are in Table 8, below:

TABLE 8
Composition of AD-AU-2110 (Picolinafen 40 +
Bromoxynil 280 + MCPA 280 EC)

| | | CAS | Purpose in |
|---|---|---|---|
| g/L | Component | number | Formulation |
| 40.6 | Picolinafen 98.5% | 137641-05-5 | Active ingredient |
| 418.5 | Bromoxynil octanoate | 1689-99-2 | Active ingredient |
| | 97.4% | | |
| 454.8 | MCPA 2-EHE 96% | 29450-45-1 | Active ingredient |
| 44 | Rhodacal 60/BE-A | 26264-06-2 | Emulsifier |
| 36 | Termul 200 | 37251-69-7 | Emulsifier |
| 184.7 | Acetophenone | 98-86-2 | Solvent |

### Example 5

### Highly Loaded Bromoxynil Formulation—Two Additional Active Ingredients

Example 5 illustrates an embodiment of the invention being similar to that in Examples 3 and 4. The total loading of the active ingredients is about 535 g/L.

This embodiment of the formulation is identified as AD-AU-2112. It has two emulsifiers and a single solvent. Details are in Table 9, below:

TABLE 9
Composition of AD-AU-2112 (Picolinafen 35 +
Bromoxynil 250 + MCPA 250 EC)

| | | CAS | Purpose in |
|---|---|---|---|
| g/L | Component | number | Formulation |
| 35.3 | Picolinafen 98.5% | 137641-05-5 | Active ingredient |
| 373.7 | Bromoxynil octanoate | 1689-99-2 | Active ingredient |
| | 97.4% | | |
| 406 | MCPA 2-EHE 96% | 29450-45-1 | Active ingredient |
| 48 | Rhodacal 60/BE-A | 26264-06-2 | Emulsifier |
| 32 | Toximul 8240 | 61791-12-6 | Emulsifier |
| 232.1 | Solvesso 150 | 64742-94-5 | Solvent |

### Example 6

### Highly Loaded Bromoxynil Formulation—Two Additional Active Ingredients

Example 6 illustrates an embodiment of the invention being similar to that in Examples 3, 4 and 5. The total loading of the active ingredients is about 575 g/L.

This embodiment of the formulation is identified as AD-AU-2201. It has two emulsifiers and a single solvent. Details are in Table 10, below:

TABLE 10
Composition of AD-AU-2201 (Picolinafen 28 + Bromoxynil 267 + MCPA 280 EC)

| | | CAS | Purpose in | |
|---|---|---|---|---|
| g/L | Component | number | Formulation | Supplier |
| 28.43 | Picolinafen | 137641-05-5 | Active | Agrogill Chemicals Pty Ltd |
| | TGAC 98.5% | | ingredient | Suite 5, 30 Woodriff St |
| | | | | Penrith NSW 2750 Australia |
| 397.82 | Bromoxynil | 1689-99-2 | Active | Jiangsu Huifeng Bio Agriculture Co, |
| | octanoate | | ingredient | Ltd, Weir Road, South Area of |
| | TGAC 97.7% | | | Ocean Economic Development |
| | | | | Zone, Dafeng, Jiangsu, P.R. China |
| 457.18 | MCPA 2- | 29450-45-1 | Active | Trustchem Co, Ltd, 89 Hangzhong |
| | EHE TGAC | | ingredient | Road, Nanjing, 210029, P.R. China |
| | 95.5% | | | |
| 42.70 | Trisol 460 | 26264-06-2 | Emulsifier | Tri-Tech Chemical Company Pty Ltd, |
| | | | | 47 Industrial Drive, Sunshine West, |
| | | | | Vic 3020 Australia |
| 35.00 | Termul 200 | 37251-69-7 | Emulsifier | Indorama Ventures Oxides |
| | | | | Australia Pty Ltd, 61 Market Road, |
| | | | | Brooklyn, Vic 3012 Australia |
| 208.04 | Acetophenone | 98-86-2 | Solvent | Solvay Chemicals Pty Ltd, |
| | | | | Technology Enterprise Centre, 2 |
| | | | | Park Drive, R&D Park, La Trobe |
| | | | | University, Bundoora, Vic 3086 |
| | | | | Australia |

Trisol 460 is a linear dodecylbenzene sulphonate, calcium salt in solvent 2-ethylhexanol. Termul 200 is oxirane, methyl-, polymer with oxirane, mono (nonylphenyl) ether. Acetophenone is 1-phenylethan-1-one.

The formulation AD-AU-2201, by way of example, was prepared as a batch process as described below.

Bromoxynil Octanoate is a waxy solid at ambient temperature and requires melting. Its melting point is 46° C. Termul 200 is a solid and requires melting. Its pour point is 30°.
1. Charge the Acetophenone into a suitable vessel equipped with a propeller type stirrer.
2. Commence mixing and add the Picolinafen Technical. Ensure complete dissolution.
3. Maintain mixing and add the Trisol 460 followed by the molten Termul 200.
4. Maintain mixing and add the MCPA 2-EHE Technical.
5. Maintain mixing and add the molten Bromoxynil Octanoate Technical.
6. Mix for a further 15 minutes then turn off the stirrer.
7. Take a representative sample of the formulation and examine the product according to the specification. Adjust active ingredient content with Acetophenone as required.

### Storage Stability

The procedures contained in the APVMA Guidelines for the Generation of Storage Stability Data for Agricultural Chemical Products (Version 3, 24 Feb. 2020) were followed to prepare ambient storage and elevated temperature samples.

5000 mL of prototype formulation AD-AU-2201 was prepared in the laboratory exactly according to the above method. 2×250 ml samples were assigned to stability study and packaged in 250 mL, COEX, HOPE containers with screw cap closure (commercial packaging material). Labels were attached to the assigned specimens in preparation for ambient and elevated temperature storage.

The specimens remained in their containers and were stored in an air-conditioned facility at approximately 21° C. for the period prior to ambient temperature and elevated temperature storage.

On the day of initiation of the accelerated storage trial, each of the specimens in their unopened containers were weighed on a top pan balance (Mettler PJ3600 Delta Range: SNR J29589) to determine a starting weight (for use as a comparison with weights at the conclusion of the storage period).

The sample designated for elevated temperature storage (Accelerated Stability sample Tas1) was placed into a thermostatically controlled oven (VWR Mini incubator: SNR 0811V1169) and heated to 54±2° C., for a period of 14 days. At the end of this period, the sample was removed from the oven and placed into a desiccation chamber to allow cooling to ambience.

The remaining AD-AU-2201 EC formulation sample (Time Zero sample To1) was stored at air-conditioned ambient temperatures (approximately 21° C.) in a locked cabinet for the duration of the elevated temperature storage period.

A sample of AD-AU-2201 EC formulation was prepared for low temperature stability testing by placing 100 ml of formulation sample (Tco1) into a 100 mL ASTM D96 graduated centrifuge tube and storing it in a refrigerated cabinet (Esatto Model EBF93W: SNR 5G386) at a temperature of 0° C.±2° C. for a total of 7 days.

TABLE 11
Results Summary Table Time Zero (Ambient) Sample (To1) - AD-AU-2201

| Determination | Method | Acceptable Limits | Analysis | Result |
|---|---|---|---|---|
| Appearance, | Visual | Clear dark amber | Clear amber liquid | PASS |
| Physical State, | | liquid | | |
| Colour | | | | |
| Odour | Olfactory | Floral, sweet (ester) | Floral, sweet (ester) | PASS |
| pH 1% v/v | CIPAC MT 75.3 | 3.00-4.00 | 3.51 | PASS |
| dilution | | | | |
| Density @ 20° C. | Density Meter | 1.160-1.180 g/mL | 1.170 g/mL | PASS |
| | Anton Paar | | | |
| | DMA 48 | | | |
| Emulsion | CIPAC MT 36.3 | Spontaneous | Spontaneous uniform | PASS |
| Characteristics | 2.0 mL/100 mL | uniform emulsion | emulsion | |
| CIPAC | | 30 min < 2.0 mL | 30 min 0.7 mL cream, | |
| Standard | | cream, trace oil | no oil | |
| Water A | | 2 h < 2.0 mL cream, | 2 h 1.0 mL cream, no | |
| | | trace oil | oil | |
| | | 24 h re- | 24 h re-emulsification | |
| | | emulsification | complete | |
| | | complete | 24.5 h 0.8 mL cream, | |
| | | 24.5 h < 2.0 mL | no oil | |
| | | cream, trace oil | | |
| Emulsion | CIPAC MT 36.3 | Spontaneous | Spontaneous | PASS |
| Characteristics | 2.0 mL/100 mL | uniform emulsion | uniform emulsion | |
| CIPAC | | 30 min < 2.0 mL | 30 min 0.05 mL | |
| Standard | | cream, trace oil | cream, no oil | |
| Water E | | 2 h < 2.0 mL cream, | 2 h 0.1 mL cream, | |
| | | trace oil | no oil | |
| | | 24 h re- | 24 h re- | |
| | | emulsification | emulsification | |
| | | complete | complete | |
| | | 24.5 h < 2.0 mL | 24.5 h 0.05 mL | |
| | | cream, trace oil | cream, trace oil | |
| Persistent Foam | CIPAC MT 47.2 | max 60 mL foam | After 10 sec: 38 mL | PASS |
| CIPAC Standard | 4.0 mL/200 mL | after 1 min | After 1 min: 35 mL | |
| Water C | | | After 3 min: 29 mL | |
| | | | After 12 min: 20 mL | |
| Content | QCM-239.01 | 25.2-30.8 g/L | 28.9 g/L | PASS |
| Picolinafen | | | | |
| Content | QCM-239.01 | 254-280 g/L | 268 g/L | PASS |
| Bromoxynil | | | | |
| present as the | | | | |
| octanoate ester | | | | |
| Content MCPA | QCM-239.01 | 266-294 g/L | 289 g/L | PASS |
| present as 2-EHE | | | | |

TABLE 12
Results Summary Table Accelerated Stability Sample (Tas1) AD-AU-2201

| Determination | Method | Acceptable Limits | Analysis | Result |
|---|---|---|---|---|
| Appearance, | Visual | Clear dark amber | Clear amber liquid | PASS |
| Physical State, | | liquid | | |
| Colour | | | | |
| Odour | Olfactory | Floral, sweet (ester) | Floral, sweet (ester) | PASS |
| pH 1% v/v | CIPAC MT 75.3 | 3.00-5.00 | 3.58 | PASS |
| dilution | | | | |
| Density @ 20° C. | Density Meter | 1.160-1.180 g/mL | 1.170 g/mL | PASS |
| | Anton Paar | | | |
| | DMA 48 | | | |
| Emulsion | CIPAC MT 36.3 | Initial emulsification | Initial emulsification | |
| Characteristics | 2.0 mL/100 mL | uniform | uniform | |
| CIPAC | | 30 min < 2.0 mL | 30 min 0.7 mL cream, | PASS |
| Standard | | cream, trace oil | no oil | |
| Water A 23° C. | | 2 h < 2.0 mL cream, | 2 h 1.3 mL cream, no | |
| | | trace oil | oil | |
| | | 24 h re- | 24 h re-emulsification | |
| | | emulsification | complete | |
| | | complete | 24.5 h 1.0 mL cream, | |
| | | 24.5 h < 2.0 mL | no oil | |
| | | cream, trace oil | | |
| Emulsion | CIPAC MT 36.3 | Initial emulsification | Initial emulsification | PASS |
| Characteristics | 2.0 mL/100 mL | uniform | uniform | |
| CIPAC | | 30 min < 2.0 mL | 30 min 0.05 mL | |
| Standard | | cream, trace oil | cream, no oil | |
| Water E 23° C. | | 2 h < 2.0 mL cream, | 2 h 0.1 mL cream, | |
| | | trace oil | no oil | |
| | | 24 h re- | 24 h re- | |
| | | emulsification | emulsification | |
| | | complete | complete | |
| | | 24.5 h < 2.0 mL | 24.5 h 0.05 mL | |
| | | cream, trace oil | cream, no oil | |
| Persistent Foam | CIPAC MT 47.2 | max 60 mL foam | After 10 sec: 35 mL | PASS |
| CIPAC Standard | 4.0 mL/200 mL | after 1 min | After 1 min: 31 mL | |
| Water C | | | After 3 min: 29 mL | |
| | | | After 12 min: 25 mL | |
| Content | QCM-239.01 | 25.2-30.8 g/L | 28.2 g/L | PASS |
| Picolinafen | | | | |
| Content | QCM-239.01 | 254-280 g/L | 261 g/L | PASS |
| Bromoxynil | | | | |
| present as the | | | | |
| octanoate ester | | | | |
| Content MCPA | QCM-239.01 | 266-294 g/L | 279 g/L | PASS |
| present as 2-EHE | | | | |

TABLE 13
Cold Temperature Stability Sample (Tcd1) - AD-AU-2201

| Determination | Method | Specification | Analysis | Result |
|---|---|---|---|---|
| Low Temperature | CIPAC MT 39.3 | <0.05 mL | <0.05 mL | PASS |
| Stability | After 7 days | separated | separated | |
| | | material | material | |

### Packaging Stability

No observable degradation, deformation, discolouration or etching of the container or lid was evident after accelerated storage. No odour was detectable emanating from the seal. No appreciable weight difference was determined over the 14 day period for both ambient and 54° C. storage conditions.

### Description of Methods Used

The methods used for testing the AD-AU-2201 formulation were the same as for the formulation in Example 1, except for certain changes as below.

Relevant test parameters for emulsifiable concentrates (EC) are given in Section 4, Table 23 of the APVMA Guidelines for the Generation of Storage Stability Data for Agricultural Chemical Products (Version 3, 24 Feb. 2020).
Density was calculated using the Anton Paar DMA 48 density meter which calculates the density of liquids and gases based on an electronic measurement of the frequency of oscillation of a U-tube containing the samples at a specified temperature.
Cold temperature stability of liquid formulations CIPAC MT-39.3 was tested by seeding the sample with crystals of the active ingredients and maintaining at ±2° C. for 7 days. The nature and volume of any separated material was recorded.
Active Constituent Content was measured using Qchem Laboratories Analytical Method QCM-239.01. Picolinafen, Bromoxynil Octanoate & MCPA 2-EHE contents were determined simultaneously by reverse phase HPLC using ultra-violet detection and external: standardisation. The method is appropriately validated as per the APVMA Guidelines for the Validation of Analytical Methods for Active Constituents and Agricultural Products (Revision 1, Jul. 1, 2014).

### Example 7

### Field Tests

Field Trials analyses were conducted to evaluate the efficacy of the highly loaded EC co-formulation of bromoxynil and fluroxypyr EC formulations of Example 2, identified as AD-AU-1624.

### Field Test 1

A field trial was conducted near Bowenville, QLD to evaluate Flagship 400 (400 gac/L fluroxypyr) and AD-AU-1624 (150 g/L fluroxypyr+300 g/L bromoxynil), for control of a seedling yellowvine (Tribulus micrococcus) in fallow.

Flagship 400 provided excellent control of yellowvine when applied at 2 and 3 L/ha 15 days after application (DAA). Near complete control was obtained with 2 and 4 L/ha AD-AU-1624.

AD-AU-1624 demonstrated bioequivalence with Flagship 400 for control of yellowvine. The results are in Table 14:

TABLE 14
Evaluation of AD-AU-1624 on yellowvine (Tribulus micrococcus)
in fallow at Bowenville, Queensland

| | Active ingredients & | Product | | | | |
|---|---|---|---|---|---|---|
| | Concentration | rate | Rate | Days after application | | |
| Treatment | (g ai/L) | (mL/ha) | (g ai/ha) | 7 | 15 | |
| Untreated | — | — | — | 0 | 0 | |
| Flagship 400 | Fluroxypyr 400 EC | 1000 | 400 | 75 c | 88 | b-e |
| Flagship 400 | Fluroxypyr 400 EC | 2000 | 800 | 73 c | 99 | abc |
| Flagship 400 | Fluroxypyr 400 EC | 3000 | 1200 | 87 abc | 100 | ab |
| AD-AU-1624 | Fluroxypyr 150 + | 2000 | 300 + 600 | 93 ab | 99 | ab |
| | Bromoxynil 300 EC | | | | | |
| AD-AU-1624 | Fluroxypyr 150 + | 4000 | 600 + 1200 | 100 a | 100 | ab |
| | Bromoxynil 300 EC | | | | | |

Means followed by the same letter are not significantly differ (P > 0.05)

### Field Test 2

A field trial was conducted near Oakey, QLD to evaluate Flagship 400 (400 gac/L fluroxypyr), Amicide Advance (700 gac/L 2,4-D) and AD-AU-1624 (150 g/L fluroxypyr+300 g/L bromoxynil) for control of advanced flax-leaf fleabane (Conyza bonariensis) in fallow.

AD-AU-1624 applied at 4 L/ha provided rapid initial knockdown and good control (90%) of flax-leaf fleabane 42 DAA. Greater than 95% control was obtained with 4 L/ha Amicide Advance and 2 L/ha AD-AU-1624. Between 80 and 95% control was provided by 2 and 3 L/ha Flagship 400, 8 L/ha Amicide Advance and 2 L/ha AD-AU-1624.

AD-AU-1624 demonstrated bioequivalence with Flagship 400 for control of flax-leaf fleabane.

The results are shown in Table 15:

TABLE 15
Evaluation of AD-AU-1624 on fleabane (Conyza bonariensis) in fallow at Oakey, Queensland

| | Active ingredients | Product | | | | | | | | | |
|---|---|---|---|---|---|---|---|---|---|---|---|
| | & Concentration | rate | Rate | Days after application | | | | | | | |
| Treatment | (g ai/L) | (mL/ha) | (g ai/ha) | 7 | | 15 | | 28 | | 42 | |
| Untreated | — | — | — | 0 | | 0 | | 0 | | 0 | |
| Amicide | 2,4-D amine 700 SL | 4000 | 2800 | 45 | bc | 50 | cd | 73 | c-f | 95 | a |
| Advance | | | | | | | | | | | |
| Amicide | 2,4-D amine 700 SL | 8000 | 5600 | 47 | bc | 55 | bcd | 77 | b-e | 92 | ab |
| Advance | | | | | | | | | | | |
| Flagship 400 | Fluroxypyr 400 EC | 1000 | 400 | 40 | cd | 45 | d | 57 | hi | 70 | cde |
| Flagship 400 | Fluroxypyr 400 EC | 2000 | 800 | 38 | cd | 47 | d | 60 | f-i | 75 | bcd |
| Flagship 400 | Fluroxypyr 400 EC | 3000 | 1200 | 38 | cd | 55 | bcd | 70 | d-h | 87 | abc |
| AD-AU-1624 | Fluroxypyr 150 + | 2000 | 300 + 600 | 53 | bc | 67 | b | 90 | ab | 88 | abc |
| | Bromoxynil 300 EC | | | | | | | | | | |
| AD-AU-1624 | Fluroxypyr 150 + | 4000 | 600 + 1200 | 58 | ab | 92 | a | 100 | a | 99 | a |
| | Bromoxynil 300 EC | | | | | | | | | | |

Means followed by the same letter are not significantly differ (P > 0.05)

### Field Test 3

A field trial was conducted near Oakey, QLD to evaluate Flagship 400 (400 gac/L fluroxypyr), Amicide Advance (700 gac/L 2,4-D) and AD-AU-1624 (150 g/L fluroxypyr+300 g/L bromoxynil) for control of advanced flax-leaf fleabane (Conyza bonariensis) in fallow.

AD-AU-1624 applied at 4 L/ha provided rapid initial knockdown and complete control of flax-leaf fleabane 44 DAA. Greater than 95% control was obtained with 2 L/ha AD-AU-1624. Between 80 and 95% control was provided by 2 and 3 L/ha Flagship 400 and 2 and 3 L/ha AD-AU-1624. Amicide Advance did not provide satisfactory control.

AD-AU-1624 demonstrated bioequivalence with Flagship 400 for control of flax-leaf fleabane.

The results are shown in Table 16 below:

TABLE 16
Evaluation of AD-AU-1624 on fleabane (Conyza bonariensis)
in fallow at Oakey, Queensland

| | Active ingredients & | Product | | | | |
|---|---|---|---|---|---|---|
| | Concentration | rate | Rate | Days after application | | |
| Treatment | (g ai/L) | (mL/ha) | (g ai/ha) | 15 | 44 | |
| Untreated | — | — | — | 0 | 0 | |
| Amicide | 2,4-D amine 700 SL | 4000 | 2800 | 57 c | 74 | g |
| Advance | | | | | | |
| Amicide | 2,4-D amine 700 SL | 8000 | 5600 | 63 bc | 79 | fg |
| Advance | | | | | | |
| Flagship 400 | Fluroxypyr 400 EC | 2000 | 800 | 71 b | 87 | d-g |
| Flagship 400 | Fluroxypyr 400 EC | 3000 | 1200 | 70 b | 90 | c-f |
| AD-AU-1624 | Fluroxypyr 150 + | 2000 | 300 + 600 | 99 a | 99 | ab |
| | Bromoxynil 300 EC | | | | | |
| AD-AU-1624 | Fluroxypyr 150 + | 4000 | 600 + 1200 | 100 a | 100 | a |
| | Bromoxynil 300 EC | | | | | |

Means followed by the same letter are not significantly differ (P > 0.05)

### Field Test 4

A field trial was conducted at Pirrinuan, QLD to evaluate the efficacy 250, 375 and 500 mL/ha Flagship 400 (400 g/L fluroxypyr) for the control of cowvine (Ipomea lonchophylla) up to 30 cm in diameter in a no-till fallow. In addition, a combination of 1000 mL/ha of a premix AD-AU-1624 (150 g/L fluroxypyr+400 g/L bromoxynil)+1000 mL/ha WipeOut Pro+Uptake was evaluated.

Commercially acceptable control (>95%) of cowvine was achieved 36 DAA with 1000 mL/ha AD-AU-1624+1000 mL/ha WipeOut Pro+Uptake (99%).

The results are shown in Table 17 below:

TABLE 17
Evaluation of AD-AU-1624 on Cowvine (Ipomoea ionchophylla)
in fallow at Pirrinuan, Queensland

| | Active ingredients | Product | | | | | | |
|---|---|---|---|---|---|---|---|---|
| | & Concentration | rate | Rate | Days after application | | | | |
| Treatment\hat{ } | (g ai/L) | (mL/ha) | (g ai/ha) | 7 | | 16 | | 36 |
| Untreated | — | — | — | 0 | | 0 | | 0 |
| Wipe Out Pro | Glyphosate 540 SL | 375 | 150 | 55 | c | 80 | c | 91 |
| Flagship 400 | Fluroxypyr 400 EC | 1000 | 540 | | | | | |
| Wipe Out Pro | Glyphosate 540 SL | 375 | 150 | 73 | b | 98 | a | 100 |
| Bronco 400 | Bromoxynil 400 SC | 750 | 300 | | | | | |
| Flagship 400 | Fluroxypyr 400 EC | 1000 | 540 | | | | | |
| Wipe Out Pro | Glyphosate 540 SL | 1000 | 540 | 91 | a | 95 | ab | 99 |
| AD-AU-1624 | Fluroxypyr 150 + | 1000 | 150 + 300 | | | | | |
| | Bromoxynil 300 EC | | | | | | | |

\hat{ }All herbicide treatments were applied with Uptake Spraying Oil at 0.5% v/v
Means followed by the same letter are not significantly differ (P > 0.05)

It will also be appreciated that each formulation of the invention is highly loaded. High loading is desirable with both bromoxynil EC solo and co-formulations due to the use rates and often large paddocks/farms that need to be treated. The benefits of high concentration formulations can be observed through the entire supply chain including:
Less volume of raw materials to procure;
Fewer litres or kilograms to formulate;
Fewer drums, labels and caps required for the same quantity of active ingredient;
Less freight and storage, from procurement of raw materials through to the end user;
Less volume for the end user to handle during mixing and application;
Fewer drums to dispose of post application; and
More cost-effective formulations for the manufacturer.

Any improvement in the delivery of the active ingredient from synthesis through to the point of application can enhance the efficiency and profitability of the agricultural chemical industry.

Field testing has demonstrated that the high loaded mixtures of the invention can perform to at least a similar standard to tank mixtures at equivalent rates. Table 13 demonstrates that AD-AU-1624 applied with glyphosate (Wipe Out) provided faster control than a tank mix of glyphosate, fluroxypyr and bromoxynil solo products. This result is of even greater significant, since the total volume of product applied as AD-AU-1624 was 12.5% less than tank mixing the solo components. In addition, AD-AU-1624 has a high flash point compared with Bronco 400 which is based on Solvesso 100 and has a lower flash point.

To apply a rate of picolinafen 25 g ai/ha+bromoxynil≥230 g ai/ha+MCPA 2-EHE≥245 g ai/ha in an EC form without using a high load bromoxynil co-formulation, end users would need to tank mix a product such as Flight at 720 mL/ha with a bromoxynil 200 EC at 400 mL/ha for a total of 1120 mL/ha of formulated product. Alternatively, they would apply Eliminar C at 1 L/ha+LVE MCPA 2-EHE 570 EC at 430 mL/ha for a total of 1430 mL/ha of formulated product. By comparison, the same minimum dose could be applied as AD-AU-2109 at ˜850 mL/ha, representing a 24 to 40% reduction in formulated product applied and eliminating the need to tank mix separate products to achieve these doses.

The application of high doses of bromoxynil either solo or in mixtures can be very effective on hard-to-control broadleaf weed species. The combination of fluroxypyr and bromoxynil in AD-AU-1624 was highly effective in simulated optical spraying trials on hard to control weeds such as yellowvine and fleabane (Tables 10 to 12). Compared to solo fluroxypyr products, the rate of fluroxypyr can be reduced by more than 50% when applied in combination with bromoxynil on these key weeds, due to the synergy between active ingredients. Compared with 2,4-D amine, the weight of active ingredient per hectare and volume of formulation product required as AD-AU-1624 to control these target weeds by a similar or greater level is <25%.

It will be noted that a highly loaded bromoxynil co-formulation such as AD-AU-1624 can provides synergistic (Colby >1) control of weeds e.g. Arctotheca calendula; when applied with florasulam.

A highly loaded bromoxynil co-formulation such as AD-AU-1624 can be applied in a wide range of situations including but not limited to winter and summer cereals, sugarcane, fallow, turf, non-crop areas, forestry, pastures. It can be applied with a spray drift reducing oil adjuvant such as Synergen OS EC 40, to improve performance.

High loaded bromoxynil co-formulation according to the invention can be suitable for use through optical spraying technology to enable high rates to be applied to up to 100% of a commercial field and primarily target the spray on susceptible target weeds.

The application of high doses of bromoxynil either solo or in mixtures can be very effective on hard to control broadleaf weed species. The combination of fluroxypyr and bromoxynil in AD-AU-1624 was highly effective in simulated optical spraying trials on hard to control weeds such as yellowvine and fleabane (Tables 10 to 12). Compared to solo fluroxypyr products, the rate of fluroxypyr can be reduced by more than 50% when applied in combination with bromoxynil on these key weeds due to the synergy between active ingredients. Compared with 2,4-D amine, the weight of active ingredient per hectare and volume of formulation product required as AD-AU-1624 to control these target weeds by a similar or greater level is <25%.

### Industrial Applicability

Each of the formulations of the invention has a solvent system with low flammability. This ensures that the formulations are safe to formulate, transport, store and apply, compared to formulations with a lower flash point. By having a higher flash point, this avoids a dangerous goods classification that requires segregation and special handling requirements during transport and storage. The formulations of the invention are also highly loaded, and have the advantages detailed in the description above.

1-37. (canceled)

38. A highly loaded bromoxynil EC formulation having low flammability and cold stability, each as herein defined, the formulation having a bromoxynil loading of more than 280 g ai/L when bromoxynil is the sole active ingredient or one of two active ingredients and at least 275 g ai/L when the formulation has at least two other active ingredients, wherein the formulation includes two emulsifiers and at least one suitable solvent, provided that:
(i) bromoxynil is not a mixture of heptanoate and butyrate esters; and
(ii) when bromoxynil is the sole active ingredient, it is not a mixture of its octanoate ester with its heptanoate ester or a mixture of its octanoate ester with its butyrate ester.

39. The formulation of claim 38, wherein bromoxynil is the sole active ingredient and the loading of bromoxynil is about 400 g ai/L.

40. The formulation of claim 38, wherein the emulsifiers are an alkylbenzene sulfonate calcium salt and an ethoxylated castor oil.

41. The formulation of claim 38, wherein the solvent is an aromatic solvent having low water solubility.

42. The formulation of claim 41, which includes a co-solvent, being NMP.

43. The formulation of claim 38, which includes a second active ingredient.

44. The formulation of claim 43, wherein the second active ingredient is fluroxypyr.

45. The formulation of claim 44, which contains about 300 g/L of bromoxynil and about 150 g/L of fluroxypyr.

46. The formulation of claim 43, wherein the emulsifiers are an alkylbenzene sulfonate calcium salt and an alkoxylated phenol.

47. The formulation of claim 43, wherein the solvent is acetophenone.

48. The formulation of claim 43, wherein the second active ingredient is (a) a HPPD inhibitor with a suitable herbicide safener or (b) MCPA.

49. The formulation of claim 48, wherein the HPPD inhibitor is chosen from pyrasulfotole, topramezone and bicyclopyrone.

50. The formulation of claim 48, wherein the herbicide safener is cloquintocet-mexyl or mefenpyr-diethyl.

51. The formulation of claim 38, wherein the formulation includes an antifoam agent.

52. The formulation of claim 43, which includes a third active ingredient.

53. The formulation of claim 52, wherein the third active ingredient is picolinafen or another suitable PDS inhibitor herbicide.

54. The formulation of claim 53, wherein the formulation contains about 275 to about 280 g/L of bromoxynil, about 280 to about 290 g/L of MCPA and about 29 to about 40 g/L of picolinafen or other suitable PDS inhibitor or blend of PDS inhibitors.

55. The formulation of claim 52, wherein the emulsifiers are an alkoxylated alkylphenol and a linear dodecylbenzene sulphonate.

56. The formulation of claim 52, wherein the solvent is acetophenone.

57. A highly loaded bromoxynil EC formulation having low flammability and cold stability, each as herein defined, the formulation having a bromoxynil loading of at least 250 g ai/L, at least two additional active ingredients, two emulsifiers and a single suitable solvent, provided that bromoxynil is not a mixture of heptanoate and butyrate esters.

58. The formulation of claim 57, wherein the additional active ingredients are chosen from a PDS inhibitor other than diflufenican, the PDS inhibitor being loaded at more than 25 g/L; and MCPA.

59. The formulation of claim 58, wherein the PDS inhibitor is picolinafen.

60. The formulation of claims 57 wherein the single solvent is acetophenone or an aromatic solvent.

61. The formulation of claim 60, wherein the aromatic solvent is a naphtha solvent or a C9 to C11 aromatic hydrocarbon.

62. The formulation of claim 60 wherein the solvent is acetophenone and is present in a concentration of less than 200 g/L.

63. The formulation of claim 57, wherein the emulsifiers are chosen from the group consisting of alkylbenzene sulfonate calcium salts, castor oil, ethoxylated castor oil, alkoxylated alkylphenols and linear dodecylbenzene sulphonates.

64. The formulation of claim 57 which includes at least one PDS inhibitor at a concentration of more than 25 g/L and MCPA 2-EHE.

65. A highly loaded bromoxynil EC formulation having a bromoxynil loading of more than 210 g ai/L, at least one additional active ingredient other than MCPA as the iso-octyl ester and including two emulsifiers and at least one suitable solvent, wherein the formulation has low flammability and cold stability and the total active ingredient loading is more than 525 g/L.

66. The formulation of claim 65 wherein the solvent is chosen from acetophenone and/or an aromatic solvent.

67. The formulation of claim 66, wherein the aromatic solvent is a naphtha solvent or a C9 to C11 aromatic hydrocarbon.
